(19) United States
(12) Patent Application Publication
(10) Pub. No.: US 2021/0292483 A1
(43) Pub. Date: Sep. 23, 2021

(54) PRODUCTION OF CROSSLINKABLE HIGH-MOLECULAR SILICON RESINS

(71) Applicant: WACKER CHEMIE AG, Munich (DE)

(72) Inventors: Frank SANDMEYER, Burgkirchen (DE); Dieter HELDMANN, Burghausen (DE)

(73) Assignee: WACKER CHEMIE AG, Munich (DE)

(21) Appl. No.: 16/482,761

(22) PCT Filed: Nov. 27, 2017
(86) PCT No.: PCT/EP2017/080556

§ 371 Date: Aug. 1, 2019

(51) Int. Cl. C08G 77/18; C09D 183/14; C09D 183/04; C08G 77/38

(52) U.S. Cl. CPC C08G 77/18; C08G 77/38; C09D 183/04; C09D 183/14

(57) ABSTRACT

Crosslinkable silicone resins of high molecular weight are produced in a multistep process by reacting a mixture of at least two different silicone resin intermediates (A) composed of units of the formula Rₐ(OR¹)_{b}O_{(4-a-b)/2} (1), having a molecular weight M_{w} of 600 to 2500 to an extent such groups OR¹ are reduced by at least 5% resulting alcohol is preferably removed by distillation to obtain silicone resins having a molecular weight M_{w} between 2500 and 10,000 g/mol, and then the silicone resins are further condensed with polyhydric alcohols in the presence of water to obtain silicone resins having a molecular weight M_{w} of 5000 to 50,000 g/mol.

### CROSS REFERENCE TO RELATED APPLICATIONS

This application is the U.S. National Phase of PCT Appln. No. PCT/EP2017/080556 filed Nov. 27, 2017, the disclosure of which is incorporated in its entirety by reference herein.

### BACKGROUND OF THE INVENTION

### 1. Field of the Invention

The invention relates to a process for producing storage-stable, crosslinkable, high molecular weight silicone resins by reaction of at least two different silicone resin oligomers containing alkoxy groups and optionally also hydroxyl groups by copolymerization with a polyhydric low molecular weight alcohol and to the use thereof for producing heat-resistant, corrosion-protective coatings.

### 2. Description of the Related Art

Processes for producing crosslinkable organopolysiloxane resins are known from numerous publications and patent documents.

U.S. Pat. No. 4,899,772 A teaches condensation-crosslinking preparations for abhesive coatings composed of a reactive crosslinked polyorganosiloxane and a reactive linear polyorganosiloxane.

The reactive crosslinked polyorganosiloxane is obtained when an alkoxy-functional, silanol-free crosslinked polyorganosiloxane is reacted with a polyhydric alcohol in the presence of a transesterification catalyst at a temperature of 100° C. to 160° C. such that the molar ratio of Si-bonded alkoxy groups to carbinol groups of the polyhydric alcohols is selected from 0.8:1 to 1.2:1 and the reaction is performed up to a degree of conversion of 25% to 90% and then terminated by cooling to below 100° C. The polyhydric alcohols are selected from polyester polyols, i.e. ester-containing polyols, obtained by reacting 1 mol of aliphatic, cycloaliphatic or aromatic dicarboxylic acids with 2 mol of an at least dihydric alcohol.

EP 0017958 A1 teaches condensation-crosslinking preparations for abhesive coatings composed of a reactive crosslinked polyorganosiloxane and a reactive linear polyorganosiloxane, wherein the relative amounts of linear polyorganosiloxane to crosslinked polyorganosiloxane differ from those in U.S. Pat. No. 4,899,772 A. The condensable preparations of EP 0017958 A1 are composed predominantly of the thermally curable silicone resin in addition to 0.05% to 4% of the linear polyorganosiloxane.

In these cases the described preparations are based on the combination of two structurally different siloxane components, namely a linear component and a crosslinked component. This aspect is explained further in EP 0679677 A2, U.S. Pat. No. 7,118,619 B2 and U.S. Pat. No. 4,452,961 A, when instead of extended pre-formed crosslinked silicone resins trialkoxysilanes are employed, or when alkoxy-functional alkoxysilanes consisting to an extent of at least 50% of cyclic monoorganoalkoxysilanes comprising 3 to 8 siloxane repeating units are employed. Neither case describes the use of exclusively crosslinked siloxane species for producing the preparations. It is also characteristic of the cited patent documents that only certain polyol-COH:siloxane-SiOR ratios, and accordingly only certain degrees of conversion, are allowed. This requires stringent reaction control and means that the processes have only limited robustness.

U.S. Pat. No. 4,749,764 A employs exclusively crosslinked/crosslinkable siloxane components as reactants. U.S. Pat. No. 4,749,764 A describes a process for producing thermally curable silicone resins. They are obtained when alkoxy-functional crosslinkable polyorganosiloxanes produced from chlorosilane precursors by hydrolysis and condensation are reacted with at least dihydric alcohols. The alcohol preferred in the examples is trimethylolpropane. In contrast to U.S. Pat. No. 4,899,772 A, no linear polyorganosiloxane components are involved here. The process and the reaction conditions for producing the polyol-crosslinked polyorganosiloxanes component correspond substantially to those described in U.S. Pat. No. 4,899,772 A. In detail, the reactive crosslinked polyorganosiloxane according to U.S. Pat. No. 4,749,764 A is obtained when an alkoxy-functional, silanol-free crosslinked polyorganosiloxane is reacted with a polyhydric alcohol in the presence of a transesterification catalyst at a temperature of 100° C. to 160° C. such that the molar ratio of Si-bonded alkoxy groups to carbinol groups of the polyhydric alcohol is selected from about one and the reaction is performed up to a degree of conversion of 25% to 80% and then terminated by cooling to below 100° C. Compared to the prior art at that time, the silicone resins according to U.S. Pat. No. 4,749,764 A had the advantage of a simpler process and improved storage stability of the uncured resins coupled with relatively faster curing rates, properties which in particular in purely crosslinkable preparations are in principle mutually exclusive and therefore difficult to realize.

While the crosslinkable polyorganosiloxanes according to U.S. Pat. No. 4,749,764 A do form tack-free films, there is a considerable delay, which is impractical, between drying as described in U.S. Pat. No. 4,749,764 A, i.e. evaporation of the solvent, and the actual reactivity-dependent formation of a tack-free film (touch-dry time). The film obtained is also not smooth, but exhibits significant surface flow problems which in practice can be compensated by the use of flow additives but entail elevated formulating cost and complexity.

Since crosslinkable polyorganosiloxanes composed of exclusively crosslinked precursors should in principle be suitable for providing harder and less thermoplastic coatings than preparations comprising a proportion of linear or cyclic polyorganosiloxanes known to those skilled in the art as plasticizing polyorganosiloxanes, the present invention accordingly has for its object to overcome the disadvantages of the prior art and provide crosslinkable polyorganosiloxanes which exhibit good storage stability coupled with high reactivity and which afford hard, corrosion-protective coatings which cure rapidly at temperatures between 10° C. and 25° C. and result in tack-free, smooth coatings. The object is achieved by the invention.

### SUMMARY OF THE INVENTION

The present invention provides a process for producing crosslinkable silicone resins, wherein in a first step a mixture of at least two different silicone resin intermediates (A) comprising Si-bonded alkoxy groups and optionally hydroxyl groups and composed of repeating units of formula (1)

RₐSi (OR¹)_{b}O_{(4-a-b)/2} (1)

wherein
R is identical or different and represents a monovalent, SiC-bonded, optionally substituted C₁-C₂₀ hydrocarbon radical,
R¹ is identical or different and represents a hydrogen atom or a radical R² ,
R² is identical or different and represents a monovalent C₁-C₆-alkyl radical,
a and b each have a value of 0, 1, 2 or 3 per repeating unit
   with the proviso that
   the sum of a+b is ≤3 and
in at least 30% of all repeating units of formula (1) a has a value of 1 and averaged over all repeating units of formula (1) a has a midpoint value of 0.9 to 1.9 and
averaged over all repeating units of general formula (1) b has a midpoint value of 0.1 to 1.8,
wherein the silicone resin intermediates (A) contain not more than 10% by weight of Si-bonded hydroxyl groups and wherein the silicone resin intermediates have a molecular weight M_{w} of 600 to 2500 g/mol,
are reacted with one another by hydrolysis and condensation in the presence of water (B),
an amount of an acidic catalyst (C) sufficient to impart acidity to the mixture and
optionally an alcohol (D) of formula R²OH, wherein R² is as defined hereinabove, as solvent
to an extent such that the amount of originally present groups —OR¹ is reduced by at least 5%, preferably by at least 7%, preferably by at least 9%, in particular by at least 12%, and the resulting alcohol is preferably removed from the reaction mixture by distillation to obtain
silicone resins (E) composed of repeating units of formula (2)

R_{c}Si (OR¹)_{d}O_{(4-c-d)/2} (2),
wherein
R and R¹ are as defined above and
c and d each have a value of 0, 1, 2 or 3 per repeating unit
   with the proviso that
   the sum of c+d is ≤3 and
in at least 30% of all repeating units of formula (1) c has a value of 1 and averaged over all repeating units of formula (1) c has a midpoint value of 0.9 to 1.9 and
averaged over all repeating units of general formula (1) d has a midpoint value of 0.05 to 1.0,
wherein the silicone resins (E) contain not more than 7% by weight of Si-bonded hydroxyl groups and
wherein the silicone resins (E) have a molecular weight M_{w} of more than 2500 g/mol and not more than 10,000 g/mol with the proviso that the silicone resins (E) have at least 1.5 times the molecular weight M_{w} of the silicone resin intermediates (A),
and in a second step
the silicone resins (E) obtained in the first step
are subjected to further condensation with polyhydric alcohols (F) bearing at least three C-bonded OH groups in the presence of water (G),
an amount of an acidic catalyst (H) sufficient to impart acidity to the mixture and
optionally of inert solvents (J)
and the resulting alcohol is preferably removed from the reaction mixture by distillation,
with the proviso that compared to the carbon-bonded OH groups (COH) in (F) the resin-bonded alkoxy groups (Si—OR¹) in (E) are present in a superstoichiometric ratio of Si—OR¹:COH of at least 2.0:1, to obtain
silicone resins (K) having a molecular weight M_{w} of 5000 g/mol to 50,000 g/mol with the proviso that the silicone resins (K) have at least 1.2 times the molecular weight M_{w} of the silicone resins (E) from the first process step,
wherein the molecular weight Mw (weight-average) is in each case determined by gel permeation chromatography and wherein in the silicone resin (K) 0.01-3% by weight of all radicals are Si—O-bonded radicals derived from the polyhydric alcohol (F) in bonded form,
3-10% by weight of all Si-bonded radicals in the silicone resin (K) represent a radical —OR², wherein R² represents a C₁-C₆-alkyl radical and
wherein the silicone resins (K) contain not more than 5% by weight of hydroxyl groups.

### DETAILED DESCRIPTION OF THE PREFERRED EMBODIMENTS

Surprisingly and in contrast to U.S. Pat. No. 4,749,764 A it has been found that the production of soluble, storage-stable, crosslinkable, high molecular weight silicone resins having a molecular weight Mw of more than 3000 g/mol and which exhibit the required properties is possible in a two-stage process, wherein in the process according to the invention in the first step Si-bonded alkoxy groups and optionally silanol-comprising crosslinked silicone resin oligomers or mixtures thereof are reacted optionally in an organic process solvent and in a second reaction step the reaction product from the first reaction step is reacted with an organic polyol to afford a high molecular weight silicone resin according to the invention, wherein the reaction is in each case carried out with an amount of an acidic condensation catalyst sufficient to impart acidity to the reaction preparation and water. The process according to the invention differs from the process according to U.S. Pat. No. 4,749,764 A in the use of a mixture of at least two different alkoxy-functional oligomers instead of only one such oligomer according to U.S. Pat. No. 4,749,764 A and the process according to the invention employs smaller amounts of the polyfunctional alcohol, i.e. an SiOR:COH ratio of >2. As a result of these differences in the process a surprisingly significant increase in the speed at which tack-free, smooth coatings are obtainable is achieved.

In the first process step the conversion is preferably driven forward to the required extent by an equilibrium shift while at the same time gelation through excessive condensation is avoided.

The amount of water (B) used in the first process step is stoichiometrically chosen such that it is sufficient to hydrolyze the desired amount of —OR² groups.

For reasons of simplicity of the process and of the recycling of the distillates it is preferable when only one type of radical —OR² is present, the process also functioning when different radicals —OR² are present on the silicone resin intermediates.

It is furthermore preferable for the same reasons to use only one alcohol R²OH whose radical R² is identical to the radical R² of the R²O groups bonded to the silicone resin intermediates. However, it is in principle possible to use a plurality of different alcohols R²OH, optionally having radicals R² different to the radical(s) R² of the Si-bonded radicals —OR², wherein a proviso for the choice of the alcohol(s) R²OH is that they completely dissolve the silicone resin intermediate(s). Since the reduced recycling rate of the distillates very likely resulting from an alcohol mixture would make the process more costly, such variants are conceivable and technically possible but not preferred.

The Si-bonded alkoxy- and optionally hydroxyl-bearing silicone resin intermediates composed of repeating units of formula (1) are produced by prior art hydrolysis and condensation processes from chlorosilane precursors, alkoxysilanes precursors or mixtures thereof. Reference is made to the process according to US 2006/0167297 A1, for example.

The catalyst (C) imparting acidity to the mixture is preferably chosen such that it does not decompose, but is volatile, under the conditions of the distillation and is therefore partially removed by distillation in this procedure but residues in the reaction mixture remain active.

It is preferable when a mixture of 2 different silicone resin intermediates of formula (1) is employed.

Said intermediates may differ in terms of the substitution pattern, i.e. for example in terms of the type and number of radicals R, such as methyl or phenyl groups, or in the type and number of functional groups —OR², such as methoxy or ethoxy groups. They may accordingly also differ in molecular weight and viscosity, though this is merely a consequence of the different composition.

In formula (1), by preference, a has the value 1 in at least 40% and preferably in at least 50% of all repeating units of formula (1) and may also have the value 1 in 100% of all repeating units of formula (1), wherein averaged over all repeating units of formula (1) preferably has a midpoint value of 0.95 to 1.9 and more preferably a value of 1.0 to 1.8 and wherein a=1 and a=2 are particularly preferred values for a in the repeating units of formula (1), and

averaged over all repeating units of general formula (1) b preferably has a midpoint value of from 0.15 to 1.6 and more preferably from 0.20 to 1.5,
wherein in the silicone resin intermediates composed of repeating units of formula (1) the radical —OR2 represents hydroxyl groups preferably to an extent of not more than 8% by weight, more preferably to an extent of not more than 5% by weight, and in particular to an extent of not more than 3% by weight. Silanol groups need not necessarily be present in the silicone intermediates composed of repeating units of formula (1). They are formed during the reaction by hydrolysis of the necessarily present alkoxy groups.

Selected examples of radicals R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as the cyclopentyl, cyclohexyl, cycloheptyl and methylcyclohexyl radicals; alkenyl radicals such as the vinyl radical; aryl radicals such as the phenyl, naphthyl, anthryl and phenanthryl radicals; alkaryl radicals such as tolyl radicals, xylyl radicals and ethylphenyl radicals; and aralkyl radicals such as the benzyl radical and

the α- and β-phenylethyl radicals, wherein this list is not intended to be limiting.

Radical R is preferably selected from unsubstituted hydrocarbon radicals having 1 to 12 carbon atoms, more preferably from methyl, ethyl and n-propyl radicals and the phenyl radical, and in particular from the methyl, n-propyl and phenyl radicals.

Examples of hydrocarbon radical R² include the radicals recited for R, wherein the radical R² is preferably a hydrogen atom or a hydrocarbon radical having 1 to 6 carbon atoms, more preferably a hydrogen atom, a methyl radical or an ethyl radical, and in particular a methyl radical, wherein this list is not to be understood as limiting.

Examples of acids employable as acidic catalyst (C) are preferably mineral acids such as hydrochloric acid, nitric acid or phosphoric acid, wherein nitric acid is particularly preferred on account of its volatility, polyacids such as polyphosphoric acid, polyacrylic acid and polyvinyl sulfuric acid, wherein carboxylic acids such as formic acid, acetic acid, propionic acid, oxalic acid, malonic acid, succinic acid, adipic acid, benzoic acid, phthalic acid, citric acid are also preferably employable. The acidic catalysts (C) are employed in amounts from 1 ppmw to 1% by weight, preferably less than 0.1% by weight, based on the total weight of the silicon resin intermediates (A), wherein gaseous acidic catalysts, such as hydrogen chloride HCl, or solid acidic catalysts are added to the reaction mass as an aqueous solution. The concentration of these aqueous solutions is 5-35% by weight, preferably 10-30% by weight, and in particular 20-25% by weight. Particular preference is given to 20-25% by weight aqueous solutions of hydrochloric acid.

When nonvolatile catalysts are employed under the conditions of the distillation, preferably a neutralization step and, for a clear product free from suspended matter, preferably a filtration are performed at the end of the reaction.

The silicone resin intermediates composed of repeating units of formula (1) have molecular weights Mw (weight-average) in the range from 600 to 2500 g/mol, preferably with a polydispersity of not more than 5. They are liquid and their viscosities are by preference in the range from 80 to 600 mPas, preferably from 85-550 mPas and more preferably from 90 to 500 mPas in each case at 25° C. and standard pressure (about 1020 hPa).

Typical examples of silicone resin intermediates (abbreviated to SM in the example numbering) composed of repeating units of formula (1) are shown hereinbelow, wherein the list is to be understood as being illustrative and nonlimiting:

### EXAMPLE SM 1

Methylphenylsilicone resin intermediate having a molecular weight average Mw of 1430 g/mol (number-average Mn=900; polydispersity 2.0) and a viscosity of 440 mm²/s (25° C.) which bears 14.2% by weight of Si-bonded methoxy groups on the surface and which is on average composed of 60 mol % of PhSiO_{3/2} units, 36 mol % of MeSiO_{3/2} units and 4 mol % of Me₂SiO_{2/2} units, wherein the methoxy groups are distributed over the specified structural units.

### EXAMPLE SM 2

Methylphenylsilicone resin intermediate having a molecular weight average Mw of 1030 g/mol (number-average Mn=730; polydispersity 1.4) and a viscosity of 140 mm²/s (25° C.) which bears 12.3% by weight of Si-bonded methoxy groups and 0.24% by weight of Si-bonded OH groups on the surface and which is on average composed of 59 mol % of PhSiO_{3/2} units and 41 mol % of Me₂SiO_{2/2} units, wherein the methoxy groups are distributed over the specified structural units.

### EXAMPLE SM 3

Phenylsilicone resin intermediate having a molecular weight average Mw of 900 g/mol (number-average Mn=700; polydispersity 1.3) and a viscosity of 300 mm²/s (25° C.) which bears 15.0% by weight of Si-bonded methoxy groups and 0.12% by weight of Si-bonded OH groups on the surface and which is composed of 100 mol % of PhSiO_{3/2} units, wherein the methoxy groups are distributed over the specified structural units.

### EXAMPLE SM 4

Methylphenylsilicone resin intermediate having a molecular weight average Mw of 1430 g/mol (number-average Mn=830; polydispersity 1.7) and a viscosity of 140 mm²/s (25° C.) which bears 12.3% by weight of Si-bonded methoxy groups and 6.3% by weight of Si-bonded butoxy groups on the surface and which is on average composed of 63 mol % of PhSiO_{3/2} units and 37 mol % of MeSiO_{3/2} units, wherein the alkoxy groups are distributed over the specified structural units.

### EXAMPLE SM 5

Methylphenylsilicone resin intermediate having a molecular weight average Mw of 1200 g/mol (number-average Mn=800; polydispersity 1.5) and a viscosity of 120 mm²/s (25° C.) which bears 13.0% by weight of silicon-bonded methoxy groups on the surface and which is on average composed of 67 mol % of PhSiO_{3/2} units and 33 mol % of MeSiO_{3/2} units, wherein the alkoxy groups are distributed over the specified structural units.

### EXAMPLE SM 6

Methylsilicone resin intermediate having a molecular weight average Mw of 2500 g/mol (number-average Mn=900; polydispersity 2.8) and a viscosity of 25 mm²/s (25° C.) which bears 36.0% by weight of Si-bonded ethoxy groups on the surface and which is on average composed of 98 mol % of MeSiO_{3/2} units, 2 mol % of M₂SiO_{2/2} units, wherein the ethoxy groups are distributed over the specified structural units.

### EXAMPLE SM 7

Methylsilicone resin intermediate having a molecular weight average Mw of 2300 g/mol (number-average Mn=600; polydispersity 3.8) and a viscosity of 20 mm²/s (25° C.) which bears 31.0% by weight of Si-bonded methoxy groups on the surface and which is on average composed of 99 mol % of MeSiO_{3/2} units and 1 mol % of Me₂SiO_{2/2} units, wherein the alkoxy groups are distributed over the specified structural units.

### EXAMPLE SM 8

Methylisooctylsilicone resin intermediate having a molecular weight average Mw of 1600 g/mol (number-average Mn=700; polydispersity 2.3) and a viscosity of 15 mm²/s (25° C.) which bears 33.0% by weight of Si-bonded methoxy groups on the surface and which is on average composed of 67 mol % of MeSiO_{3/2} units and 33 mol % of ⁱOctSiO_{3/2} units, wherein the alkoxy groups are distributed over the specified structural units.

### EXAMPLE SM 9

Methylsilicone resin intermediate having a molecular weight average Mw of 2900 g/mol (number-average Mn=1400; polydispersity 2.1) and a viscosity of 150 mm²/s (25° C.) which bears 9.0% by weight of Si-bonded ethoxy groups on the surface and which is on average composed of 70 mol % of MeSiO_{3/2} units, 25 mol % of Me₂SiO_{2/2} units and 5 mol % of Me₃SiO_{1/2} units, wherein the alkoxy groups are distributed over the specified structural units.

The first process step is performed by preference at a temperature of 30° C. to 180° C., preferably 35° C. to 160° C. The first process step is preferably performed at the pressure of the ambient atmosphere, i.e. about 1020 hPa, but may also be performed at higher or lower pressures.

The first process step affords silicone resins (E) composed of repeating units of formula (2)

R_{c}Si (OR¹)_{d}O_{(4-c-d)/2} (2),

wherein R and R¹ are as defined above and
c has the value 1 by preference in at least 40% and preferably in at least 50% of all repeating units of formula (2) and may also have the value 1 in 100% of all repeating units of formula (2), and averaged over all repeating units of formula (1) c has a midpoint value of by preference 0.95 to 1.9 and preferably a value of 1.0 to 1.8, wherein c=1 and c=2 are particularly preferred values for c in the repeating units of formula (2), in particular c=1,
averaged over all repeating units of general formula (1) d has a midpoint value of by preference 0.08 to 0.90 and preferably from 0.10 to 0.80,
wherein in the silicone resins composed of repeating units of formula (2) the unit OR² represents hydroxyl groups preferably to an extent of not more than 5% by weight, particularly preferably not more than 4% by weight, in particular not more than 3% by weight. Silanol groups need not be present in the silicone intermediates composed of repeating units of formula (2). They are formed during the reaction by hydrolysis of the necessarily present alkoxy groups.

The silicone resin intermediates composed of repeating units of formula (2) have molecular weights Mw (weight-average) in the range from more than 2500 g/mol and not more than 10,000 g/mol with a polydispersity of preferably not more than 25 and are preferably liquid.

The difference in the molecular weight Mw between the employed silicone resin intermediates composed of repeating units of formula (1) and the silicone resins composed of repeating units of formula (2) is at least 1.5 times that of the silicone resin intermediate composed of repeating units of formula (1), i.e.

in the mixture of at least 2 different silicone resin intermediates composed of repeating units of formula (1) at least 1.5 times the molecular weight of the silicone resin intermediate having the lowest molecular weight, preferably at least 1.8 times, in particular at least 2 times. The molecular weight of the silicone resins composed of repeating units of formula (2) is the specified number of times higher than the molecular weight of the silicone resin intermediates composed of formula (1) or in the mixture of silicone resin intermediates composed of repeating units of formula (1) than the particular silicone resin intermediate composed of repeating units of formula (1) having the lowest molecular weight Mw.

The staged increase in the molecular weight from stage to stage is a special and essential feature of the process according to the invention. If the increase in molecular weight specified here is not achieved then the performance of the end products described hereinbelow in the examples is not achieved. In particular the combination of rapid drying at room temperature coupled with good crosslinkability to afford a solvent-resistant, corrosion-protective, hard coating is not achieved.

In the process according to the invention in the second stage/in the second reaction step the silicone resins (E) composed of repeating units of formula (2) obtained in the first stage are subjected to further condensation in the presence of a polyhydric alcohol (F) bearing at least three carbon-bonded OH groups to afford the end product according to the invention.

It is a particular feature of the process according to the invention that distinguishes it from the prior art that the resin-bonded alkoxy groups (Si-OR¹) in (E) are in a marked excess compared to the carbon-bonded OH groups (COH) in the alcohol (F) bearing at least three C-bonded OH groups. The Si—OR¹: COH ratio, i.e. the ratio of the silicone-bonded alkoxy groups to the C-bonded OH groups of the alcohol is preferably at least 2.25:1, in particular at least 2.5:1.

The employed polyhydric alcohols (F) are by preference alcohols having 3 to 4 C-bonded OH groups, preferably three C-bonded OH groups.

It is preferable to employ polyhydric alcohols (F) of formula

R³ (—OH)ₓ,

wherein R³ represents a trivalent to polyvalent hydrocarbon radical having 5 to 25 C. atoms which is optionally interrupted by one or more heteroatoms, preferably oxygen atoms and carbonyl groups,
x is an integer from 3 to 20, by preference 3 to 4, preferably 3.

Examples of polyhydric alcohols (F) comprising at least 3 C-bonded OH groups are trimethylolethane, trimethylolpropane, ditrimethylolpropane, glycerol, pentaerythritol and polyols of formula (4)

R⁵-OC (═O)—R⁶—C (═O) O—R⁷ (4)

or mixtures of the recited examples.

Here, R⁵ and R⁷ represent identical or different monovalent, linear, branched or cyclic aliphatic saturated hydrocarbon radicals comprising 2 to 15 carbon atoms and comprising at least one carbinol group, wherein the sum of the carbinol groups of both radicals R⁵ and R⁷ together must be at least 3. Accordingly if a radical R⁵ has only one carbinol group then radical R⁷ must simultaneously comprise at least 2 carbinol groups.

Radicals R⁶ are divalent linear, branched, cyclic or aromatic hydrocarbon radicals having 2 to 12 carbon atoms.

Examples of radicals R⁵ and R⁷ are HO (CH₂)₂-; HO (CH₂)₃-; H₃C—CH (OH)—CH₂-; HO—H₂C—C (CH₃)₂CH₂-; (HOCH₂)₃C—CH₂-; H₃C—C (CH₂OH)₂CH₂-; HO—H₂C—CH (OH)—CH₂-; H₅C₂—C (CH₂OH)₂—CH₂.

Preference is given to polyhydric alcohols (F) comprising at least 3 C-bonded OH groups which are as small as possible, i.e. have the fewest possible carbon atoms,

since larger organic radicals have the disadvantage of scorching in high temperature applications in particular so that binders comprising larger organic radicals exhibit a corresponding shrinkage which results in stresses and poorer performance of the coating.

For process engineering reasons preference is in particular given to those polyhydric alcohols (F) comprising at least three C-bonded OH groups that are soluble in water or methanol to a solids content of at least 50% by weight, in particular those soluble in water to an extent of at least 50% by weight. Preferred examples are trimethylolethane, trimethylolpropane, ditrimethylolpropane and glycerol. Particularly preferred examples are ditrimethylolpropane and trimethylolpropane. A most preferred example is trimethylolpropane.

Preferably obtained after the second process step are silicone resins (K) composed of repeating units of formula (3):

R_{c}Si (OR⁴)_{d}O_{(4-c-d)/2} (3)

wherein
R, c and d are as defined above,
R⁴ is identical or different and is a radical R², wherein R² is a C₁-C₆-alkyl radical,
or R⁴ is a monovalent radical R³′, wherein R³′ derives from the polyhydric alcohol (F) bearing at least three C-bonded OH groups minus at least one of the OH groups, wherein R³′ preferably represents a monovalent hydrocarbon radical having 5 to 25 carbon atoms which is optionally interrupted by one or more heteroatoms, preferably oxygen atoms and carbonyl groups, and optionally contains one or more OH groups,
or R⁴ represents a bridging radical R³*, wherein R³* bridges two or more repeating units of formula (3) via two or more —OR⁴ groups and derives from the polyhydric alcohol (F) bearing at least three C-bonded OH groups minus at least two of the OH groups, wherein R³* preferably represents a divalent to polyvalent hydrocarbon radical having 5 to 25 carbon atoms which is optionally interrupted by one or more heteroatoms, preferably oxygen atoms and carbonyl groups, and which optionally also contains one or more OH groups, with the proviso that in the silicone resin (K) 0.01-3% by weight of all radicals are Si—O-bonded radicals R³′ and R³* derived from the polyhydric alcohol (F) in bonded form,
3-10% by weight of all Si-bonded radicals represent a radical —OR⁴ , wherein R⁴ represents a C₁-C₆-alkyl radical R², and
not more than 5% by weight of Si-bonded hydroxyl groups are present.

Radicals R⁴ in the silicone resin (K) of formula (3) are radicals of the type R², wherein R² is a C₁-C₆-alkyl radical, or the radical R⁴ may be a monovalent radical R³′, wherein R³′ preferably represents a C₅-C₂₅-alkyl radical, C₅-C₂₅-cycloalkyl radical or optionally a cyclic alkyl-comprising C₅-C₂₅-aralkyl radical which may optionally be interrupted by one or more heteroatoms and which optionally contains one or more OH groups,

or the radical R⁴ may represent a bridging radical R³*, wherein R³* preferably represents a C₅-C₂₅-alkylene, C₅-C₂₅-cycloalkylene or optionally a cyclic alkyl-comprising C₅-C₂₅-aralkylene radical bridging two or more repeating units of formula (3) which may optionally be interrupted by one or more heteroatoms, preferably oxygen atoms or carbonyl groups, and which optionally contains one or more OH groups.

The radicals R³′ and the radicals R³* bridging two or more repeating units of formula (3) are formed by the reaction of the silicone resins (E) composed of repeating units of formula (2) with the polyhdric alcohols (F) bearing at least 3 C-bonded OH groups. These result in bridging units having a crosslinking effect between the different silicone resin repeating units of formula (3) or in terminally bonded units still comprising carbon-bonded OH groups.

In the repeating units of formula (3) by preference 0.02-2.0% by weight, preferably 0.03-1.0% by weight, in particular 0.04-0.6% by weight, of all radicals represent an Si—O-bonded radical R³*, wherein R³* is as defined above.

In the repeating units of formula (3) 3-10% by weight of all Si-bonded radicals represent a radical OR⁴, wherein R⁴ represents a C₁-C₆-alkyl radical R², wherein in these cases the methyl radical and the ethyl radical are particularly preferred for the radical R⁴, especially the methyl radical. Preferably 3.0-9.5% by weight of all Si-bonded radicals represent a radical OR⁴ , wherein R⁴ represents a monovalent C₁-C₆-alkyl radical R², particularly preferably 3.5-9.0% by weight, in particular 3.5%-8.5% by weight.

In the silicone resins composed of repeating units of formula (3) the units OR⁴ represent silicon-bonded hydroxyl groups preferably to an extent of not more than 4% by weight, particularly preferably not more than 3% by weight, in particular not more than 2% by weight. Silanol groups need not be present in the silicone resins (K) composed of repeating units of formula (3). They may be formed during the reaction by hydrolysis of the necessarily present alkoxy groups even if the silicone resins composed of repeating units of formula (2) are used for production do not themselves contain any hydroxyl groups.

In the second process step hydrolysis and condensation are in turn effected through the use of water (G) as a reaction partner for the hydrolysis and with a catalyst (H) which imparts acidity to the reaction mixture. The same catalysts as previously described for the catalysts (C) of the first stage are suitable and preferred. HCl in the form of a 20-25% aqueous solution in particular is preferred here too.

The amount of water (G) is in turn measured at least such that it is stoichiometrically sufficient for the amount of alkoxy groups to be hydrolyzed. The alcohol formed in the condensation is optionally distilled off in admixture with water to shift the equilibrium of the condensation reaction toward the side of the condensates. The second stage is preferably performed using an inert solvent (J). At commencement of performance of the second stage the inert solvent is added in an amount such that the mixture of silicone resin (K) composed of repeating units of formula (3) and the inert solvent considered in and of itself would afford a 40% to 90% solution, i.e. a solution that would comprise 40% to 90% by weight of resin and accordingly 60% to 10% by weight of inert solvent. It is preferable when an amount of the inert solvent is added such that a 45% to 85%, particularly preferably a 50% to 85%, in particular a 50% to 85%, resin solution as just described hereinabove would be formed when considering solely the amounts of resin and inert solvent present.

The second process step is performed by preference at a temperature of 40° C. to 180° C., preferably 45° C. to 170° C. The second process step is preferably performed at the pressure of the ambient atmosphere, i.e. about 1020 hPa, but may also be performed at higher or lower pressures.

After termination of the reaction it is preferable when any remaining amounts of water and alcohol and the added inert solvent are completely distilled off and the obtained reaction mass is then taken up in a suitable inert solvent which may optionally be different from the organic solvent added during the reaction phase of the second stage, but preferably is not different, to afford a homogeneous mixture. The amount of finally added organic solvent is chosen according to requirements.

To the extent that it is volatile the acid used during the second stage is preferably expelled during the distillation of the solvents or optionally neutralized by neutralization with a suitable base. Any salt generated is removed by filtration. It is preferable to choose a volatile acid, in particular hydrochloric acid, which is expelled during the distillation so that no neutralization is required.

Suitable bases for neutralization are alkali metal hydroxides such as sodium hydroxide and potassium hydroxide, alkali metal siliconate's such as sodium siliconate and potassium siliconate, amines such as for example trimethylamine, ethylamine, diethylamine, triethylamine and n-butylamine, ammonium compounds such as tetramethylammonium hydroxide, tetra-n-butylammonium hydroxide, benzyltrimethylammonium hydroxide, alkoxides such as sodium methoxide, potassium methoxide and sodium or potassium ethoxide, wherein sodium hydroxide, potassium hydroxide, sodium methoxide and sodium ethoxide are particularly preferred.

Suitable inert water-insoluble solvents (J) include any solvents which dissolve the silicon resin (K) to a sufficient extent while simultaneously having a water solubility of less than 2000 mg/l in water at 20° C. These are in particular aromatic solvents, such as toluene and the various xylene isomers, or mixtures thereof or corresponding aromatic distillation cuts. Xylene isomers and mixtures thereof are preferred.

The molecular weight Mw of the silicone resins (K) composed of repeating units of formula (3) is preferably at least 1.4 times, in particular at least 1.6 times, the molecular weight of the silicone resins (E) composed of repeating units of formula (2).

The staged increase in the molecular weight from stage to stage is a special and essential feature of the process according to the invention. If the increase in molecular weight specified here is not achieved then the performance of the end products described hereinbelow in the examples is not achieved. In particular the combination of rapid drying at room temperature coupled with good crosslinkability to afford a solvent-resistant, corrosion-protective, hard coating is not achieved.

The silicones (K) composed of repeating units of formula (3) have molecular weights Mw (weight-average) in the range from 5000 to 50,000 g/mol, preferably with a polydispersity of not more than 25. As pure resins they are preferably high viscosity liquids or solids.

They feature high storage stability, wherein the storage stability may optionally be further improved by addition of stabilizers. Suitable stabilizers (L) are those that react with the remaining acid traces or that react with remaining traces of water. They are preferably liquid or solids that are soluble in the inventive resins (K) composed of repeating units of formula (3).

Examples of stabilizers (L) that react with acid traces are for instance epoxy-functional compounds such as epoxidized soybean oil, amines such as trialkylamines for example tri-n-octylamine or triisooctylamine. Typical examples of water scavengers are acetals of acetone, such as 2,2 dimethoxypropane and 2,2-dimethyl-1,3-dioxolane.

The high molecular weight silicone resins (K) produced by the process according to the invention are particularly suitable for use in corrosion-protective preparations. They are especially suitable for use for the purpose of corrosion protection at high temperature.

Apart from the purpose of high temperature-resistant corrosion protection the high molecular weight silicone resins produced by the process according to the invention may also be used for corrosion protection of reinforcing steel in steel-reinforced concrete, wherein the compounds according to the invention may be employed both in pure form and in preparations. Corrosion-inhibiting effects in steel-reinforced concrete are achieved not only when the compounds according to the invention or preparations which contain these are introduced into the concrete mixture before it is molded and cured but also when the compounds according to the invention or preparations which contain these are applied to the surface of the concrete after the concrete has cured.

In addition to the purpose of corrosion protection on metals the high molecular weight silicone resins produced by the process according to the invention may also be used for manipulation of further properties of preparations which contain the high molecular silicone resins produced by the process according to the invention or of solid articles or films obtained from preparations which contain the high molecular weight of silicone resins produced by the process according to the invention, such as for example:
controlling electrical conductivity and electrical resistance
controlling the flow properties of a preparation
controlling the gloss of a moist or cured film or of an object
increasing weathering resistance
increasing chemicals resistance
increasing color fastness
reducing chalking propensity
reducing or increasing the static and sliding friction on solids or films obtained from preparations containing the preparation according to the invention
stabilizing or destabilizing foam in the preparation containing the preparation according to the invention
increasing the adhesion of the preparation containing the high molecular weight silicone resins produced by the process according to the invention to substrates onto which or between which the preparation containing high molecular weight silicone resins produced by the process according to the invention is applied,
controlling filler and pigment wetting and dispersion characteristics,
controlling the rheological properties of the preparation containing the high molecular weight silicone resins produced by the process according to the invention,
controlling the mechanical properties, for example flexibility, scratch resistance, elasticity, extensibility, bending capacity, breaking characteristics, resilience characteristics, hardness, density, tear propagation resistance, compression set, behavior at different temperatures, coefficient of expansion, abrasion resistance and also further properties such as thermal conductivity, combustibility, gas permeability, stability to water vapor, hot air, chemicals, weathering and radiation, sterilizability of solid bodies or films containing the high molecular weight silicone resins produced by the process according to the invention or preparations containing these
controlling electrical properties, for example dielectric loss factor, breakdown resistance, dielectric constant, leakage current resistance, arc resistance, surface resistivity, specific breakdown resistance,
flexibility, scratch resistance, elasticity, extensibility, bending capacity, breaking characteristics, resilience characteristics, hardness, density, tear propagation resistance, compression set and behavior at various temperatures of solid bodies or films obtainable from the preparation containing the high molecular weight silicone resins produced by the process according to the invention.

Examples of applications in which the preparation according to the invention may be employed to manipulate the described properties are the production of coating compositions and impregnations and coatings obtainable therefrom on substrates such as metal, glass, wood, mineral substrates, artificial and natural fibers for producing textiles, carpets, floor coverings or other goods producible from fibers, leather, plastics such as films and moldings. With appropriate selection of preparation components the high molecular weight silicone resins according to the invention may also be used in preparations as an additive for the purposes of defoaming, flow promotion, hydrophobization, hydrophilization, filler and pigment dispersion, filler and pigment wetting, substrate wetting, surface smoothness promotion, reduction of static and sliding friction on the surface of the cured mass obtainable from the additized preparation. The high molecular weight silicone resins obtainable by the process according to the invention may be incorporated into elastomer masses in liquid or in cured solid form. They may be used for the purpose of reinforcing or for improving other performance properties such as controlling transparency, heat resistance, propensity for yellowing, or weathering resistance.

All abovementioned symbols of the abovementioned formulae are each defined independently of one another. The silicon atom is tetravalent in all formulae.

### EXAMPLES

The process according to the invention is described hereinbelow in examples. All percentages are based on weight. Unless otherwise stated all manipulations were performed at room temperature of about 23° C. and under standard pressure (1.013 bar). Apparatuses employed are commercial laboratory instruments such as are commercially available from numerous instrument manufacturers.

Ph represents a phenyl radical=C₆H₅-
Me represents a methyl radical=CH₃-. Me₂ accordingly represents two methyl radicals.

In the present text substances are characterized by reporting data obtained using instrumental analysis. The underlying measurements are performed either according to publicly available standards or are determined according to specially developed methods. To ensure clarity of the imparted teaching the methods employed are specified hereinbelow.

In all examples all specified values of parts and percentages are based on weight unless otherwise stated.

### Viscosity:

Unless otherwise stated viscosities are determined by rotational viscometry according to DIN EN ISO 3219. Unless otherwise stated all reported viscosities are at 25° C. and standard pressure of 1013 mbar.

### Refractive Index:

Refractive indices are determined in the wavelength range of visible light at 589 nm at 25° C. and standard pressure of 1013 mbar according to the standard DIN 51423 unless otherwise stated.

### Transmission:

Light transmission is determined by UV VIS spectroscopy. One suitable instrument is, for example, the Analytik Jena Specord 200 instrument.

The measurement parameters used are: range: 190-1100 nm step width: 0.2 nm, integration time: 0.04 s, measurement mode: step mode. The reference (background) measurement is performed first. A quartz plate secured to a sample holder (dimension of quartz plates: h×w about 6×7 cm, thickness about 2.3 mm) is placed into the sample beam path and measured against air. Sample measurement follows. A quartz plate secured to the sample holder and having the sample applied to it—layer thickness of applied sample about 1 mm—is placed into the sample beam path and measured against air. Internal calculation versus the background spectrum gives the transmission spectrum of the sample.

### Molecular Compositions:

Molecular compositions are determined using nuclear magnetic resonance spectroscopy (for terminology see ASTM E 386: High-resolution nuclear magnetic resonance (NMR) spectroscopy: terms and symbols), by measuring the ¹H nucleus and the ²⁹Si nucleus.

Description of ¹H-NMR measurement

Solvent: CDCl₃, 99.8% d

Sample concentration: about 50 mg/1 ml of CDCl₃ in 5 mm NMR tubes

Measurement without addition of TMS, spectral referencing of residual CHCl₃ in CDCl₃ at 7.24 ppm

Spectrometer: Bruker Avance I 500 or Bruker Avance HD 500

Probe: 5 mm BBO probe or SMART probe (Bruker)

### Measurement Parameters:

Pulprog=zg30

TD=64k

NS=64 or 128 (depending on sensitivity of probe)

SW=20.6 ppm

AQ=3.17 s

D1=5 s

SFO1=500.13 MHz

O1=6.175 ppm

### Processing Parameters:

SI=32k

WDW=EM

LB=0.3 Hz

Depending on the spectrometer type used, individual adjustments for the measurement parameters may be required.

### Description of ²⁹Si-NMR Measurement

Solvent: C₆D₆ 99.8% d/CCl₄ 1:1 v/v with 1% by weight of Cr(acac)₃ as relaxation reagent

Sample concentration: about 2 g/1.5 ml of solvent in 10 mm NMR tubes

Spectrometer: Bruker Avance 300

Probe: 10 mm 1H/13C/15N/29Si glass-free QNP probe (Bruker)

### Measurement Parameters:

Pulprog=zgig60

TD=64k

NS=1024 (depending on sensitivity of probe)

SW=200 ppm

AQ=2.75 s

D1=4 s

SFO1=300.13 MHz

O1=−50 ppm

### Processing Parameters:

SI=64k

WDW=EM

LB=0.3 Hz

Depending on the spectrometer type used, individual adjustments for the measurement parameters may be required.

### Molecular Weight Distributions:

Molecular weight distributions are determined as the weight-average Mw and the number-average Mn using the methods of gel permeation chromatography (GPC) and size exclusion chromatography (SEC) with a polystyrene standard and a refractive index detector (RI-Detektor). Unless otherwise stated THF is used as eluent and DIN 55672-1 is followed. Polydispersity is the quotient Mw/Mn.

### Glass Transition Temperatures:

The glass transition temperature is determined by differential scanning calorimetry, DSC, according to DIN 53765, holed crucible, heating rate 10 K/min.

### Determination of Particle Size:

The particle sizes were determined by the method of dynamic light scattering (DLS) using the zeta potential. The following surgery materials and reagents were used for the determination:

Polystyrene cuvettes of 10×10×45 mm, Pasteur pipettes for single use, ultrapure water.

The sample to be measured is homogenized and filled into the measuring cuvette avoiding bubble formation.

After an equilibration time of 300 seconds high resolution measurement is carried out at 25° C. with automatic measuring time adjustment.

The reported values always relate to the D(50) value. D(50) is to be understood as meaning the volume-averaged particle diameter at which 50% of all measured particles have a volume-average diameter smaller than the specified value D(50).

### Example 1

### Production of a Silicone Resin by the Inventive Two-Stage Process.

### First Stage:

In a 4 l four-necked flask fitted with a reflux cooler and a dropping funnel 1890.0 g of the silicone resin intermediate SM (alkoxy content 14.2% by weight, Mw=1430 g/mol) is mixed with 210.0 g of the silicone resin intermediate SM 2 (12.3% by weight of alkoxy groups, Mw=1030 g/mol) and 900.0 g of methanol under nitrogen. This affords a clear, low-viscosity preparation.

To this mixture are added 96.2 g of an aqueous hydrochloric acid solution produced by mixing 4.20 g of 20% aqueous HCl solution with 92 g of fully deionized water. The addition of the aqueous hydrochloric acid-containing preparation takes 10 min.

The mixture becomes cloudy and undergoes slight warming, the observed exothermicity corresponding to 4° C. under the chosen conditions so that the end temperature after addition is 23° C. The mixture is then heated at a heating rate of 40° C./h to its reflux temperature of 65° C. The mixture clarifies during heating. The mixture is held at reflux for 2 h.

The mixture is cooled to room temperature. 3.80 g of a 30% sodium methoxide solution in methanol is subsequently added. The mixture is subsequently pH neutral.

The volatile constituents are removed on a rotary evaporator at 80° C. and 10 mbar of subatmospheric pressure. The obtained residue is subsequently diluted with xylene such that an 80% solution in xylene is obtained, i.e. the preparation contains 80% of the silicone resin and 20% xylene.

2.0 g of DICALITE® Perlite Filterhilfe 478 (Sud Chemie) are added as a filtration aid and the mixture is filtered via a vacuum filter funnel fitted with a Seitz K 100 filter sheet.

This affords a clear, colorless solution.

The residual methoxy content of the resin is 6.55% by weight and is thus more than 50% lower than the average methoxy content of the starting mixture of 14.01% by weight.

The following molecular weights were determined by SEC (eluent THF): Mw=3800 g/mol, Mn=1300 g/mol, polydispersity PD=2.9. Mw is more than twice as high as for the employed silicone resin intermediates SM 1 and SM 4.

The molar composition according to ²⁹Si-NMR is as follows:
Me₂Si (OMe) O_{1/2:}2.93%
Me₂SiO_{2/2}:7.3%
Me (OMe)₂SiO_{1/2}:1.54%
Me (OMe) SiO_{2/2}:9.23%
MeSiO_{3/2}:24.1%
Ph (OMe)₂SiO_{1/2}:0.60
Ph (OMe) SiO_{2/2}:27.5%
PhSiO_{3/2}:26.8%

The solution obtained after filtration proves viscosity stable and thus storage stable upon storage in a drying cabinet (4 weeks at 60° C.)

Second stage:

In a 4 l four-necked flask fitted with a reflux cooler and a dropping funnel 1800.0 g of the 80% xylenic silicone resin solution from the first stage of this example containing 1440.0 g of silicone resin, i.e. 0.38 mol of resin, is mixed with 28.8 g (0.21 mol) of trimethylolpropane (2% based on the silicone resin in the 1800.0 g of solution) under nitrogen. The mixture is cloudy.

The silicone resin contains 6.55% by weight of methoxy groups (MeO having a molecular weight of 31 g/mol) and therefore 1440 g of silicone resin contain 94.32 g/3.04 mol of methoxy groups.

0.21 mol of trimethylolpropane contain 0.62 mol hydroxyl groups, thus giving a molar Si-OMe:COH ratio of 5.0:1.

To this mixture are added 141.8 g of an aqueous hydrochloric acid solution produced by mixing 3.60 g of 20% aqueous HCl solution with 138.2 g of fully deionized water. The addition of this aqueous hydrochloric acid-containing preparation takes 10 min.

The mixture remains cloudy, exothermicity is not observed under the chosen conditions. The temperature of the mixture after completed hydrochloric acid addition is 22° C. The mixture is then heated at a heating rate of 40° C./h. The mixture begins to reflux from 94.2° C. The mixture clarifies during heating. The mixture is held at reflux for 2 h.

The mixture is cooled to room temperature. 3.31 g of a 30% sodium methoxide solution in methanol is subsequently added. The mixture is subsequently pH neutral.

The volatile constituents are completely removed on a rotary evaporator at 150° C. and 10 mbar of subatmospheric pressure. The obtained residue is subsequently diluted with xylene such that an 80% solution in xylene is obtained, i.e. the preparation contains 80% of the silicone resin and 20% xylene. This affords a clear, colorless solution.

The residual methoxy content of the resin is 5.38% by weight. The following molecular weights were determined by SEC (eluent THF): Mw=10,482 g/mol, Mn=1653 g/mol, polydispersity PD=6.34.

The molar composition according to ²⁹Si—NMR is as follows:
Me₂Si (OMe) O_{1/2}: 0.7%
Me₂SiO_{2/2}: 8.7%
Me (OMe) ₂SiO_{1/2}: 1.0%
Me (OMe) SiO_{2/2}: 10.6%
MeSiO_{3/2}: 22.3%
Ph (OMe)₂SiO_{1/2}: 0.5%
Ph (OMe) SiO_{2/2}: 27.6%
PhSiO_{3/2}: 28.6%

The solution obtained after filtration proves viscosity stable and thus storage stable over more than 4 weeks at 60° C. upon storage in a drying cabinet.

Obtained on an aluminum panel from the inventive final resin solution after application with a 100 μm doctor blade and evaporation of the solvent after 1.2 h is a dry, tack-free, smooth, glossy film.

### Example 2

### Production of a Silicone Resin by the Inventive Two-Stage Process

In contrast to the first example the first stage is not isolated in this example but rather subjected to further reaction immediately in the second step.

In a 60 l glass apparatus fitted with cooling and addition means and a heating jacket 30672 g of the silicone resin intermediate SM 1 (alkoxy content 14.2% by weight, Mw=1430 g/mol) is mixed with 3408 g of the silicone resin intermediate SM 2 (12.3% by weight of alkoxy groups, Mw=1030 g/mol) and 14605 g of methanol under nitrogen. This affords a clear, low-viscosity preparation.

To this mixture are added 1314.6 g of an aqueous hydrochloric acid solution produced by mixing 69.6 g of 20% aqueous HCl solution with 1245 g of fully deionized water. The addition of this aqueous hydrochloric acid-containing preparation takes 10 min.

The mixture becomes cloudy and undergoes slight warming, the observed exothermicity corresponding to 4.6° C. under the chosen conditions so that the end temperature after addition is 27.5° C. The mixture is then heated at a heating rate of 40° C./h to a jacket temperature of 80° C.

The mixture clarifies during heating. A vacuum of 300 mbar is then applied over 3 min and distillative removal of the resulting methanol in admixture with a small amount of water is commenced. 16.48 kg of distillate are removed over 50 min. The distillate contains 99% methanol and 1% water. The resin formed has the following properties: Mw=4871 g/mol, Mn=1460 g/mol, PD=3.34. The content of silicone-bonded methoxy groups is determined as 7.01% by weight and is therefore half of the average methoxy content of the starting mixture of the silicone resin intermediate. The silicone resin content of the solution was not directly analyzed but can be estimated to about 31,690 g based on the starting weights and the available analytical data.

The vacuum is broken, heating is commenced and subsequently 7860 g of xylene and 1252 g of a 50% aqueous solution of trimethylolpropane are added, i.e. 626 g of trimethylolpropane, which corresponds to 1.98% by weight of the calculated amount of resin from the first step. This results in an Si—OR:COH ratio of 5.1:1.

After xylene addition the HCl content of the reaction mixture is 140 ppm. 2370.82 g of an aqueous hydrochloric acid solution produced by mixing 25.82 g of 20% aqueous HCl solution with 2345 g of fully deionized water are added over 5 min.

A vacuum of 100 mbar is subsequently applied and the jacket temperature is set to 100° C. Under these conditions 4803 g of distillate composed of water, methanol and xylene are removed. The jacket temperature is increased to 150° C. and the vacuum is increased to 20 mbar. A further 7390 g of distillate composed of xylene and a small amount of methanol is removed over 45 min. Heating is commenced and 7600 g of xylene are added.

This affords 38.6 kg of an 80.5% clear, colorless resin solution in xylene.

The residual methoxy content of the resin is 6.10% by weight. The following molecular weights were determined by SEC (eluent THF): Mw=12495 g/mol, Mn=1870 g/mol, polydispersity PD=6.68.

The molar composition according to ²⁹Si-NMR is as follows:
Me₂Si (OMe) O_{1/2}: 0.6%
Me₂SiO_{2/2}: 9.2%
Me (OMe)₂SiO_{1/2}: 1.1%
Me (OMe) SiO_{2/2}: 11.4%
MeSiO_{3/2}: 25.4%
Ph(OMe)₂SiO_{1/2}: 0.3%
Ph(OMe)SiO_{2/2}: 29.7%
PhSiO_{3/2}: 22.3%

After addition of 1000 ppm of epoxidized soybean oil (obtainable under the name DRAPEX 39 from Galata Chemicals, 68623 Lampertheim, Germany) based on the amount of silicone resin present the solution proves stable over more than 4 weeks at 60° C. upon storage in a drying cabinet.

Obtained on an aluminum panel from the inventive final resin solution after application with a 100 μm doctor blade and evaporation of the solvent after 1.0 h is a dry, tack-free, smooth, glossy film.

### Example 3

### Production of a Silicone Resin by the Inventive Two-Stage Process.

In contrast to example 1 the first stage is not isolated and a particularly robust procedure is chosen which is especially suitable for scaleup.

### First Stage:

In a 2 l four-necked flask fitted with a reflux cooler and a dropping funnel 882.0 g of the silicone resin intermediate SM 1 (alkoxy content 14.2% by weight, Mw=1430 g/mol) is mixed with 98.0 g of the silicone resin intermediate SM 2 (12.3% by weight of alkoxy groups, Mw=1030 g/mol) and 420.0 g of methanol under nitrogen. This affords a clear, low-viscosity preparation.

To this mixture are added 32.0 g of an aqueous hydrochloric acid solution produced by mixing 2.0 g of 20% aqueous HCl solution with 30.0 g of fully deionized water. The addition of the aqueous hydrochloric acid-containing preparation takes 10 min.

The mixture becomes cloudy and undergoes slight warming, the observed exothermicity corresponding to 4° C. under the chosen conditions so that the end temperature after addition is 25° C.

The mixture is subsequently heated at a heating rate of 40° C./h at standard pressure of 1013 mbar but not refluxed, removal of distillate instead being commenced immediately (reactive distillation).

The mixture clarifies during heating. Distillation is continued until an internal temperature of 120° C. has been achieved (3.5 h).

This affords 503.3 g of distillate which consists substantially of methanol (99% by weight) and water. This distillate may be reused in subsequent batches without further workup. The amount of water present is to be accounted for in the batch calculation.

The silicone resin from the first stage contains 5.98% by weight of methoxy groups (MeO having a molecular weight of 31 g/mol) and therefore the obtained 896.3 g of silicone resin contain 83.69 g/2.7 mol of methoxy groups.

### Second Stage:

Added to the distillation residue from the first stage are 226 g of xylene, 2.0 g of 20% aqueous hydrochloric acid solution and 22.5 g of a solution of 80% by weight of trimethylolpropane in water

(=0.13 mol trimethylolpropane) corresponding to 2% by weight of trimethylolpropane based on the silicone resin. 0.13 mol of trimethylolpropane corresponds to 0.39 mol hydroxyl groups, thus giving a molar Si-OMe:COH ratio of 7.0:1.

The mixture is not heated during the addition. The internal temperature falls to 70° C. The mixture is subsequently heated to reflux (oil bath temperature 160° C.) for 1 h. After one hour removal of distillate is commenced, the pressure in the reaction vessel carefully being reduced from 1013 mbar to 20 mbar. 252.9 g of distillate are obtained after 30 min. 40 g of a 25% by weight brine solution are added to the distillate to improve phase separation. The phases are then separated. The organic phase consists substantially of xylene (98.1% by weight) and a small amount of methanol and water and may be reused without any further treatment. The small amounts of water and methanol are to be accounted for when calculating subsequent batches.

The distillation residue is cooled to 60° C. and 108 g of xylene are added to establish a solids content of 80% by weight.

The residual methoxy content of the resin is 4.79% by weight.

The following molecular weights were determined by SEC (eluent THF): Mw=17161 g/mol, Mn=2080 g/mol, polydispersity PD=8.3.

Free trimethylolpropane is not detectable. 1.89% by weight are found bound in the resin.

The molar composition according to ²⁹Si-NMR is as follows:
Me₂Si (OMe) O_{1/2}: 0.5%
Me₂SiO_{2/2}: 9.1%
Me (OMe)₂SiO_{1/2}: 0.2%
Me (OMe) SiO_{2/2}: 9.4%
MeSiO_{3/2}: 25.7%
Ph (OMe)₂SiO_{1/2}: 0.7%
Ph (OMe) SiO_{2/2}: 27.2%
PhSiO_{3/2}: 27.2%

The solution obtained after filtration proves stable over more than 4 weeks at 60° C. upon storage in a drying cabinet.

Obtained on an aluminum panel from the inventive final resin solution after application with a 100 μm doctor blade and evaporation of the solvent after 1.2 h is a dry, tack-free, smooth, glossy film.

Comparative Example 1

### Resin Synthesis According to Example 1 of U.S. Pat. No. 4,749,764 A

Since no procedure for the synthesis of the precursor of example 1 in U.S. Pat. No. 4,749,764 A is given and only a general reference to the prior art is made, a synthesis procedure was derived according to the prior art known at the date of U.S. Pat. No. 4,749,764 A. Reference is made here to DE854708, GB1192506, DE953661, U.S. Pat. No. 2,758,124, and DE2415331 for example.

Production comprises the steps of partial alkoxylation, hydrolysis and condensation and also work up by aqueous washing operations in the presence of an inert aromatic solvent:

Weighed into a 4 l four-necked flask fitted with a dropping funnel and a reflux cooler are 745 g (3.52 mol) of phenyltrichlorosilane and 144.9 g of dimethyldichlorosilane (1.12 mol).

At room temperature of 23° C. 369.6 g of methanol were added over 50 minutes. The temperature falls as a result of outgassing of hydrogen chloride initially to −5.7° C. before then increasing to 16° C., the end temperature after completed methanol addition. The mixture is subsequently heated to 60° C. and stirred at this temperature for 15 min. At 60° C. 60 g of water are added dropwise over 60 min, the temperature increasing to 69.1° C. and the mixture becoming cloudy. Heating is discontinued, the mixture is allowed to cool to 45° C. over 20 min with stirring before 45.5 g of trimethylchlorosilane (0.42 mol) is added at this temperature over 6 min. The mixture is heated over 2 h to 67.3° C. which is reflux temperature. 660 g of xylene, 660 g of water and 200 g of 30% aqueous NaCl solution are added, the mixture is heated to 60° C. and then stirred for 10 min. Stirring is discontinued and the phases are left to separate for 30 min without heating.

The lower phase (acidic water) is removed. The washing procedure is repeated three times in each case with 750 ml of water and in each case at 60° C. with a phase separation time of 30 min. After the third washing operation the residual HCl content has fallen to 5 ppm. The organic phase is subjected to rotary evaporation at 80° C. and 10 mbar of vacuum until no more distillate is obtained.

The obtained resin has a proportion of silicon-bonded methoxy groups of 7.43% by weight. Mw=1480 g/mol, Mn=944 g/mol, PD=1.57.

The molar composition according to ²⁹Si-NMR is as follows:
Me₃SiO_{1/2}: 4.0%
Me₂Si (OMe) O_{1/2}: 2.6%
Me₂SiO_{2/2}: 17.2%
Ph (OMe)₂SiO_{1/2}: 8.8%
Ph (OMe) SiO_{2/2}: 42.0%
PhSiO_{3/2}: 25.4%

312.5 g of this preliminary product are initially charged with 15.98 g of trimethylolpropane, 3.7 g of ethylene glycol, 0.5 g of 10% xylenic solution of butyl titanate and 187.5 g of xylene in a 2 l four-necked flask fitted with a dropping funnel and reflux cooler and heated to a heating bath temperature of 150° C. with stirring. First distillate of methanol and xylene is obtained from 77° C. The reaction is continued until 38% of the silicon-bonded methanol has been distilled off. The reaction time was altogether 5 h at a heating bath temperature of 150° C. The reaction is terminated by cooling and addition of a further 140 g of xylene. A 50% xylenic solution is obtained. The solution has a viscosity at 25° C. of 76 cSt.

The obtained resin has a proportion of silicon-bonded methoxy groups of 4.52% by weight. Based on the starting amount of 7.43% by weight of methoxy groups 60.83% thereof have been retained, i.e. a conversion rate based on methoxy groups of 39.17%. Mw=4003 g/mol, Mn=1692 g/mol, PD=2.37.

The molar composition according to ²⁹Si-NMR is as follows:
Me₃SiO_{1/2}: 4.1%
Me₂Si (OMe) O_{1/2}: 0.6%
Me₂SiO_{2/2}: 18.9%
Ph (OMe)₂SiO_{1/2}: 0.7%
Ph (OMe) SiO_{2/2}: 34.8%
PhSiO_{3/2}: 40.9%

The solution obtained after filtration proves viscosity stable upon storage in a drying cabinet at 50° C. as previously described in EP 0006432.

Obtained on an aluminum panel from the fresh resin solution after application with a 100 μm doctor blade and evaporation of the solvent is a tacky film. After 24 hours the film is still not tack-free. A tack-free surface is obtained only after 35 hours. The film has an uneven surface structure attributable to flow problems.

1-11. (canceled)

12. A process for producing crosslinkable silicone resins, comprising:
in a first step, reacting with one another, by hydrolysis and condensation in the presence of water (B):
a mixture of at least two different silicone resin intermediates (A) comprising Si-bonded alkoxy groups and optionally hydroxyl groups and comprising repeating units of formula (1)
RₐSi(OR¹)_{b}O_{(4-a-b)/2} (1),
wherein
R is identical or different and represents a monovalent, SiC-bonded, optionally substituted C₁-C₂₀ hydrocarbon radical,
R¹ is identical or different and represents a hydrogen atom or a radical R²,
R² is identical or different and represents a C₁-C₆-alkyl radical,
a and b each have a value of 0, 1, 2 or 3 per repeating unit with the proviso that the sum of a+b is ≤3 and
in at least 30% of all repeating units of formula (1) a has a value of 1, averaged over all repeating units of formula (1) a has a midpoint value of 0.9 to 1.9, and
averaged over all repeating units of general formula (1) b has a midpoint value of 0.1 to 1.8,
wherein the silicone resin intermediates (A) contain not more than 10% by weight of Si-bonded hydroxyl groups and
wherein the silicone resin intermediates have a molecular weight M_{w} of 600 to 2500
in the presence of an amount of an acidic catalyst (C) sufficient to impart acidity to the mixture, and
optionally an alcohol (I)) of formula R²OH, wherein R² is as defined above, as a solvent, reacting proceeding to an extent such that the amount of originally present groups —OR¹ is reduced by at least 5% and the resulting alcohol is optionally removed from the reaction mixture by distillation to obtain silicone resins (E) comprising repeating units of formula (2)
R_{c}Si(OR¹)_{d}O_{(4-c-d)/2} (2),
wherein
R and R¹ are as defined above and
c and d each have a value of 0, 1, 2 or 3 per repeating unit with the proviso that the sum of c d is ≤3 and
in at least 30% of all repeating units of formula (1) c has a value of 1, averaged over all repeating units of formula (1) c has a midpoint value of 0.9 to 1.9, and
averaged over all repeating units of formula (1) d has a midpoint value of 0.05 to 1.0,
wherein the silicone resins (E) contain not more than 7% by weight of Si-bonded hydroxyl groups and
wherein the silicone resins (E) have a molecular weight M_{w} of more than 2500 g/mol and not more than 10,000 g/mol, with the proviso that silicone resins (E) have at least 1.5 times the molecular weight M_{w} of the silicone resin intermediates (A):
and in a second step, further condensing
the silicone resins (E) obtained in the first step
with polyhydric alcohols (F) bearing at least three C-bonded OH groups, in the presence of water (G), and in the presence of an amount of an acidic catalyst (H) sufficient to impart acidity to the mixture,
optionally one or more inert solvents (J), and optionally removing the resulting alcohol from the reaction mixture by distillation,
with the proviso that compared to the carbon-bonded OH groups (COH) in (F) the resin-bonded alkoxy groups (Si-OR¹) in (E) are present in a superstoichiometric ratio of Si-OR¹:COH of at least 2.0:1, to obtain silicone resins (K) having a molecular weight M_{w} of 5000 g/mol to 50,000 g/mol, with the proviso that the silicone resins (K) have at least 1.2 times the molecular weight M_{w} of the silicone resins (E) from the first process step,
wherein the molecular weight Mw (weight-average) is in each case determined by gel permeation chromatography and
wherein in the silicone resin (K) 0.01-3% by weight of all radicals are Si—O-bonded radicals derived from the polyhydric alcohol (F) in bonded form,
3-10% by weight of all Si-bonded radicals in the silicone resin (K) represent a radical —OR², wherein R² represents a C₁-C₆-alkyl radical and
wherein the silicone resins (K) contain not more than 5% by weight of hydroxyl groups.

13. The process of claim 12, wherein R is a methyl or phenyl radical.

14. The process of claim 12, wherein. R² is a methyl radical.

15. The process of claim 13, wherein R² is a methyl radical.

16. The process of claim 12, wherein polyhydric alcohols (F) employed are alcohols having three to four C-bonded OH groups.

17. The process of claim 12, wherein the polyhydric alcohols (F) bear at least three C-bonded OH groups, and are those of formula
R³(—OH)ₓ,
wherein R³ represents a trivalent to polyvalent hydrocarbon radical having 5 to 25 C atoms which is optionally interrupted by heteroatoms, or carbonyl groups,
x is an integer from 3 to 20.

18. The process of claim 12, wherein the polyhydric alcohols (F) bear at least three C-bonded OH groups, and are those of formula
R³(—OH)ₓ,
wherein R³ represents a trivalent to polyvalent hydrocarbon radical having 5 to 2.5 C atoms which is optionally interrupted by heteroatoms, or carbonyl groups,
x is an integer from 3 to 4.

19. The process of of claim 12, wherein the polyhydric alcohols (F) bear at least three C-bonded OH groups and are one or more of trimethylolethane, trimethylolpropane, ditrimethylo propane or glycerol.

20. The process of claim 11, wherein after the second process step, silicone resins (K) are obtained which comprise repeating units of formula (3):
R_{c}Si(OR⁴)_{d}O_{(4-c-d)/2} (3)
wherein
R, c and d are as defined in claim 12,
R⁴ is identical or different and is a radical R², wherein R² is a C₁-C₆-alkyl radical, or R⁴ is a monovalent radical R³′, wherein R³′ derives from the polyhydric alcohol (F) bearing at least three C-bonded OH groups minus at least one of the OH groups, wherein R³′ optionally represents a monovalent hydrocarbon radical having 5 to 25 carbon atoms which is optionally interrupted by one or more heteroatoms or carbonyl groups, and optionally contains one or more OH groups,
or R⁴ represents a bridging radical R³*, wherein. R³* bridges two or more repeating units of formula (3) is two or more -OW groups and derives from the polyhydric alcohol (F) bearing at least three C-bonded OH groups minus at least two of the OH groups, wherein R³* preferably represents a divalent to polyvalent hydrocarbon radical having 5 to 25 carbon atoms which is optionally interrupted by one or more heteroatoms or carbonyl groups, and which optionally also contains one or more OH groups,
with the proviso that in the silicone resin (K)
0.01-3% by weight of all radicals are Si—O-bonded radicals R³′ and R³* derived from the polyhydric alcohol in bonded form,
3-10% by weight of all Si-bonded radicals represent a radical —OR⁴, wherein R⁴ represents a C₁-C₆-alkyl radical R², and
not more than 5% by weight of Si-bonded hydroxyl groups are present.

21. The process of claim 12, wherein HCl is employed as the catalysts (C) and (H).

22. The process of claim 12, wherein xylenes are employed as an inert solvent (J).

23. A corrosion-protective composition comprising at least one silicone resin produced as claimed in claim 12,

24. A coating for corrosion protection comprising at least one silicone resin produced as claimed in claim 12.
